(19) United States
(12) Patent Application Publication
(10) Pub. No.: US 2011/0042881 A1
(43) Pub. Date: Feb. 24, 2011

(54) SHEET PROCESSING APPARATUS AND A SHEET PROCESSING METHOD

(75) Inventor: Shinichiro MANO, Kanagawa (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/857,411

(22) Filed: Aug. 16, 2010

Related U.S. Application Data
(60) Provisional application No. 61/235,301, filed on Aug. 19, 2009.

(51) Int. Cl. B41F 13/66; B65H 1/00

(52) U.S. Cl. 270/58.11; 271/145

(57) ABSTRACT

A sheet processing apparatus of an embodiment includes a processing tray on which a sheet conveyed from an image forming apparatus is placed, a stapler to staple the sheet placed on the processing tray, a sheet discharge mechanism to discharge the stapled sheet from the processing tray to a discharge port, a liftable storage tray on which the sheet discharged from the discharge port is stacked, and a guide material which is provided on the storage tray and guides insertion of a sheet when the sheet is inserted from the discharge port into the stapler and manual stapling is performed.

### CROSS-REFERENCE TO RELATED APPLICATION

This application is based upon and claims the priority of U.S. Provisional Application No. 61/235,301, filed on Aug. 19, 2009, the entire contents of which are incorporated herein by reference.

### FIELD

Embodiments described herein relate generally to a sheet processing apparatus and a sheet processing method for stapling sheets discharged from an image forming apparatus such as a copying machine, a printer or a multi-function peripheral (MFP).

### BACKGROUND

In recent years, a sheet processing apparatus is adjacent to a latter stage of an image forming apparatus (for example, MFP) in order to finish a sheet afterimage formation. The sheet processing apparatus is called a finisher, and staples or sorts sheets sent from the MFP and discharges.

The finisher includes a lateral alignment plate to control the position of a sheet in a width direction, and sheets are aligned in the width direction, are conveyed to a stapler and are stapled. The lateral alignment plate is used also when sheets are sorted and are discharged. Besides, there is also a case where stapling is desired to be performed by a manual operation.

When stapling is manually performed, a sheet bundle is inserted into the stapler from a sheet discharge port of the finisher, and the stapler is operated. However, in the manual stapling, there is a case where the sheet bundle is not aligned or the position of stapling is shifted, and stapling can not be correctly performed.

### BRIEF DESCRIPTION OF THE DRAWINGS

FIG. 1 is a whole structural view showing an embodiment of a sheet processing apparatus.

FIG. 2 is a structural view of a finisher.

FIG. 3 is a perspective view showing a structure of the periphery of a processing tray when seen from a discharge port of the finisher.

FIG. 4 is a perspective view showing a structure of a processing tray and a conveyance belt.

FIG. 5 is a perspective view showing a structure of a stapler.

FIG. 6 is a perspective view showing an insertion example of a sheet in manual stapling.

FIG. 7 a plan view showing an example of an operation panel for manual stapling.

FIG. 8 is a perspective view of a storage tray when seen from a processing tray side.

FIG. 9 is a perspective view showing a state where a sheet bundle is inserted into a processing tray.

FIG. 10 is a perspective view showing a state where a sheet bundle different in size is inserted.

FIG. 11A to FIG. 11C are plan views showing an insertion example of a sheet bundle in a manual mode and staple positions.

FIG. 12 is a perspective view showing a storage tray provided with an openable and closable guide material.

FIG. 13 is a perspective view showing a storage tray provided with a retractable guide material.

FIG. 14 is a plan view showing an insertion example of a sheet bundle using the guide material of FIG. 12.

FIG. 15 is a plan view showing an insertion example of a sheet bundle using the guide material of FIG. 13.

FIG. 16 is a structural view showing the storage tray provided with the retractable guide material.

FIG. 17 is a block diagram showing a control system of an image forming apparatus and a finisher.

### DETAILED DESCRIPTION

According to an aspect of the invention, a sheet processing apparatus includes a processing tray on which a sheet conveyed from an image forming apparatus is placed, a stapler to staple the sheet placed on the processing tray, a sheet discharge section to discharge the stapled sheet from the processing tray to a discharge port, a liftable storage tray on which the sheet discharged from the discharge port is stacked, and a guide material which is provided on the storage tray and guides insertion of the sheet when the sheet is inserted from the discharge port into the stapler and manual stapling is performed.

Hereinafter, a sheet processing apparatus of an embodiment will be described in detail with reference to the drawings. Incidentally, in the drawings, the same portion is denoted by the same reference numeral.

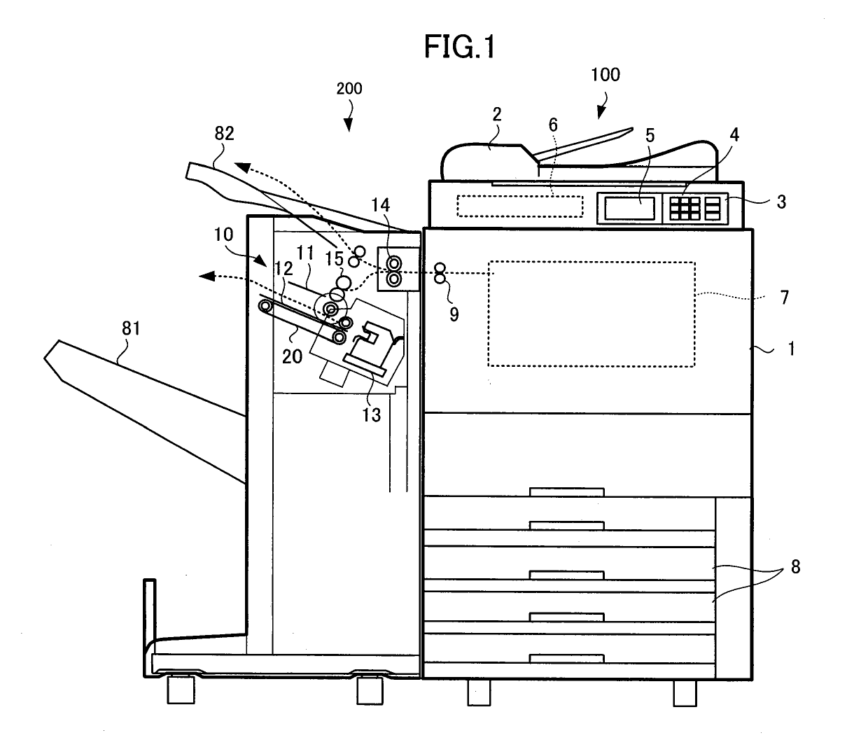

FIG. 1 is a structural view showing an image forming apparatus including a sheet processing apparatus.

In FIG. 1, reference numeral 100 denotes the image forming apparatus, which is, for example, an MFP (Multi-Function Peripherals), a printer, a copying machine or the like. A sheet processing apparatus 200 is disposed adjacently to the image forming apparatus 100. The sheet processing apparatus 200 hereinafter-called the finisher 200.

A sheet on which an image is formed by the image forming apparatus 100 is conveyed from the image forming apparatus 100 to the finisher 200. The finisher 200 performs finishing on the sheet supplied from the image forming apparatus 100, and performs, for example, stapling, sorting or the like.

A document table is provided on an upper part of a body 1 of the image forming apparatus 100, and an auto document feeder (ADF) 2 is openably and closably provided on the document table. An operation panel 3 is provided on an upper part of the body 1. The operation panel 3 includes an operation section 4 having various keys and a touch panel type display section 5.

A scanner section 6 and a printer section 7 are provided in the inside of the body 1, and plural cassettes 8 containing various sizes of sheets are provided at a lower part of the body 1. The scanner section 6 reads a document sent by the ADF 2 or a document placed on the document table.

The printer section 7 includes a photoconductive drum, a laser and the like, scans and exposes the surface of the photoconductive drum with and to a laser beam from the laser, and forms an electrostatic latent image on the photoconductive drum. A charging device, a developing device, a transfer device and the like are disposed around the photoconductive drum. The electrostatic latent image of the photoconductive drum is developed by the developing device, and a toner image is formed on the photoconductive drum. The toner image is transferred to a sheet by the transfer device. The structure of the printer section 7 is not limited to the foregoing example, and various types are adopted.

A sheet on which an image is formed in the body 1 is conveyed to the finisher 200 by a discharge roller 9. In the example of FIG. 1, the finisher 200 includes a staple unit 10 for stapling a sheet bundle. The sheet finished by the finisher 200 is discharged to a storage tray 81 or a fixed tray 82. The storage tray 81 can move up and down.

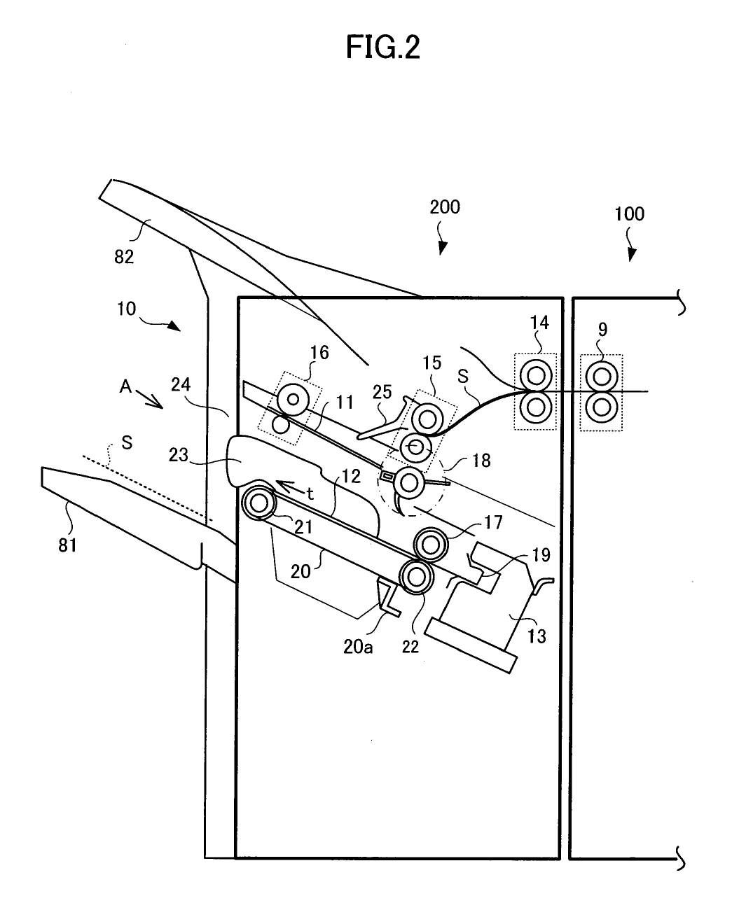

FIG. 2 is a structural view of the staple unit 10 of the finisher 200. A sheet S discharged from the discharge roller 9 of the image forming apparatus 100 is conveyed to the staple unit 10.

The staple unit 10 includes a standby tray 11, processing tray 12 and a stapler 13. The sheet S discharged by the discharge roller 9 of the image forming apparatus 100 is received by an inlet roller 14 provided at a carry-in port of the stapler unit 10. The inlet roller 14 includes an upper roller and a lower roller and is driven by a motor.

A paper feed roller 15 is provided downstream of the inlet roller 14. The sheet S received by the inlet roller 14 is sent to the standby tray 11 through the paper feed roller 15. The paper feed roller 15 includes an upper roller and a lower roller, and the paper feed roller 15 is driven by a motor. The processing tray 12 for stacking the sheet S dropped from the standby tray 11 is disposed below the standby tray 11.

The standby tray 11 stacks the sheet S and has an openable structure. When a specified number of sheets S are stacked, the standby tray 11 is opened, and the sheets S are dropped to the processing tray 12 by their own weight or operation of a drop assist member to forcibly drop. The processing tray 12 supports the sheets S during a period when the stapler 13 staples the sheets S.

The sheets dropped to the processing tray 12 are guided to the stapler 13 by a roller 17 and are stapled. The roller 17 is driven by a motor, and the roller 17 rotates in opposite directions between when the sheets S are guided to the stapler 13 and when the stapled sheets S are discharged.

When sheets are stapled, the plural sheets S dropped from the standby tray 11 to the processing tray 12 are aligned in the vertical direction as the conveying direction, and are aligned in the lateral direction perpendicular to the conveying direction and are stapled. A lateral alignment part 23 is provided to align the sheets S in the lateral direction. The lateral alignment part 23 performs alignment and sorting of the sheets S (the details will be described later). The stapler 13 and the lateral alignment part 23 constitute a finishing section of the staple unit 10, and performs finishing such, as stapling or sorting.

Besides, in order to assist dropping of the sheets to the processing tray 12, a rotatable paddle 18 is provided at a position where the trailing edges of the sheets S drop. The paddle 18 is attached to a rotation shaft, flaps down the sheets S dropped from the standby tray 11 onto the processing tray 12, and sends the sheets S toward the stapler 13.

A stopper 19 to regulate the trailing edge position of the sheets S is provided at the end of the processing tray 12 on the stapler 13 side. Besides, a conveyance belt 20 is provided to convey the sorted or stapled sheets S to the storage tray 81. The conveyance belt 20 is stretched between pulleys 21 and 22, and a pawl member 20a to hook and send the trailing edges of the sheets S is attached to the conveyance belt 20. A mechanism to rotate the pulleys 21 and 22 is omitted.

The conveyance belt 20 rotates in an arrow t direction, so that the sheets are discharged from a discharge port 24 to the storage tray 81. The storage tray 81 is moved up and down by a motor and receives the sheets S. The conveyance belt 20 and the pawl member 20a constitute a sheet discharge section to guide the stapled sheets S to the discharge port 24.

Besides, when the sheets S stacked on the standby tray 11 are discharged to the storage tray 81 without being stapled, the sheets S are not dropped to the processing tray 12 but are discharged by a rotation roller 16. Besides, the sheet S not required to be stapled can also be discharged to the fixed tray 82. A conveyance path is provided to guide the sheet S to the fixed tray 82. A swingable assist arm 25 is attached to an attachment shaft of the upper roller of the paper feed roller 15. The assist arm 25 protrudes to the discharge side of the paper feed roller 15, and presses the sheet to the standby tray 11 so that the trailing edge side of the sheet discharged from the paper feed roller 15 does not rise.

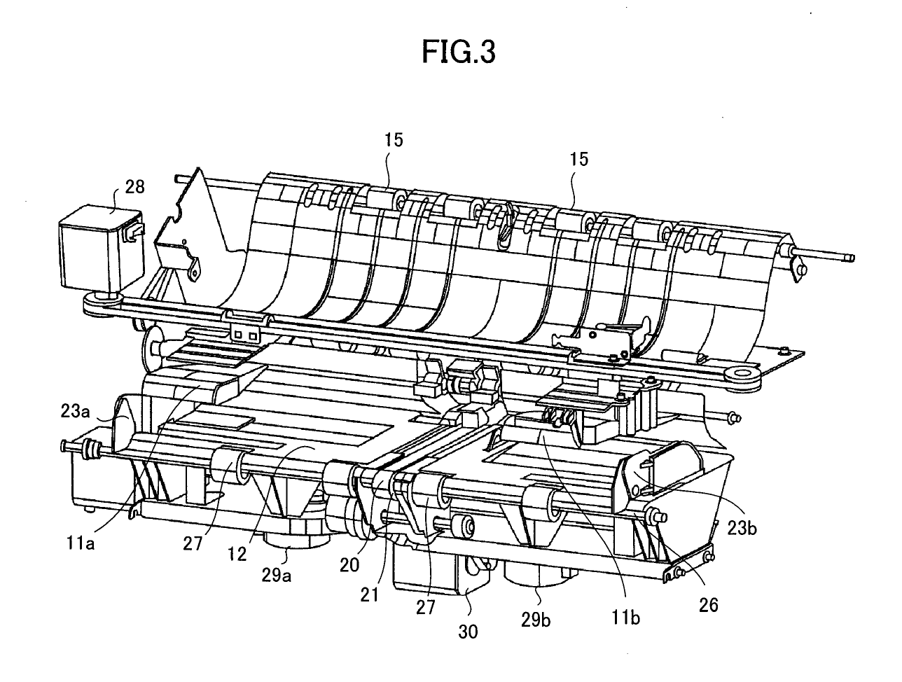

FIG. 3 is a perspective view of a main part of the staple unit 10 and is a view seen in an arrow A direction of FIG. 2. FIG. 3 mainly shows the standby tray 11, the processing tray 12 and a peripheral mechanism.

In FIG. 3, a shaft 26 is disposed perpendicularly to the conveying direction of the sheet S, the pulley 21 is attached to an intermediate part of the shaft 26, and the conveyance belt 20 is stretched over the pulley 21. The conveyance belt 20 is stretched between the pulley 21 and the pulley 22 (FIG. 2). The conveyance belt 20 is rotated by a motor 30, and is circularly rotated and moved between the stapler 13 and the discharge port 24 along the discharge direction of the sheet. Discharge rollers 27 are attached to the center and both sides of the shaft 26, and rotate when the sheet S is discharged to the storage tray 81.

The standby tray 11 includes a pair of tray members 11a and 11b, and supports both ends of the sheet S in the width direction. The tray members 11a and 11b can move in the width direction of the sheet S by a motor 28. The lateral alignment part 23 is provided on the processing tray 12. The lateral alignment part 23 includes a pair of lateral alignment plates 23a and 23b provided at both sides of the processing tray 12. The tray members 11a and 11b and the lateral alignment plates 23a and 23b can slide in the width direction of the sheet, and the lateral alignment plates 23a and 23b align the sheets dropped from the tray members 11a and 11b. The lateral alignment plate 23a and 23b move in the direction parallel to the shaft 26 by motors 29a and 29b.

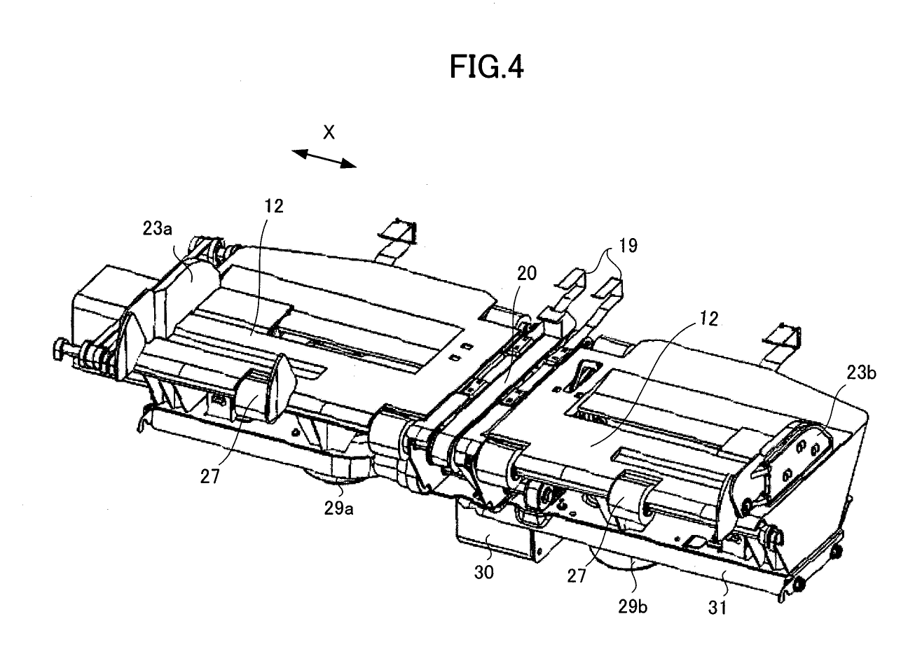

FIG. 4 is a perspective view showing a structure of the peripheral part of the processing tray 12, the conveyance belt 20 and the discharge roller 27. The lateral alignment plates 23a and 23b are provided at both sides of the processing tray 12 so as to be movable in an arrow X direction. The conveyance belt 20 is provided at the center of the processing tray 12. The motor 30 to drive the conveyance belt 20 and the motors 29a and 29b to drive the lateral alignment plates 23a and 23b in the arrow X direction are attached to a frame 31.

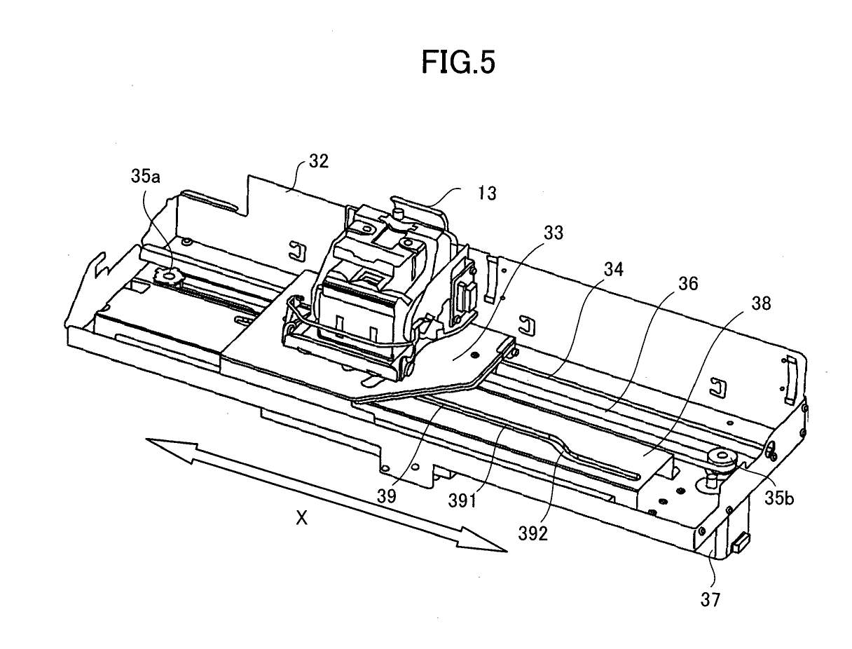

FIG. 5 is a perspective view showing a structure of the stapler 13. The stapler 13 is attached on a movement plate 33 accommodated in a frame 32. The movement plate 33 moves along a rail 34. An endless belt 36 is stretched between pulleys 35a and 35b in order to move the movement plate 33, and the endless belt 36 is fixed to the movement plate 33. The pulley 35b is forwardly and reversely rotated by the motor 37, so that the movement plate 33 moves in the arrow X direction.

A stand 38 is provided in parallel to the endless belt 35, and a slit 39 is formed in the stand 38. The slit 39 includes a straight portion 391 extending in parallel to the rail 34 and an inclined portion 392. The stapler 13 is rotatably attached to the movement plate 33, and a pin provided at the bottom of the stapler 13 is inserted in the slit 39.

While the movement plate 33 moves in the straight portion 391 of the slit 39, stapling, can be performed on the trailing edge portion (for example, two positions) of the sheet. Besides, when the movement plate 33 is moved to the position of the inclined portion 392 of the slit 39, and the pin reaches the position of the inclined portion 392, the stapler 13 rotates by about 45 degrees, and can staple a corner of the sheet.

Besides, although the finisher 200 can staple the sheets S by the stapler 13, the user uses the stapler 13 and can staple sheets by a manual operation. Hereinafter, called a manual mode.

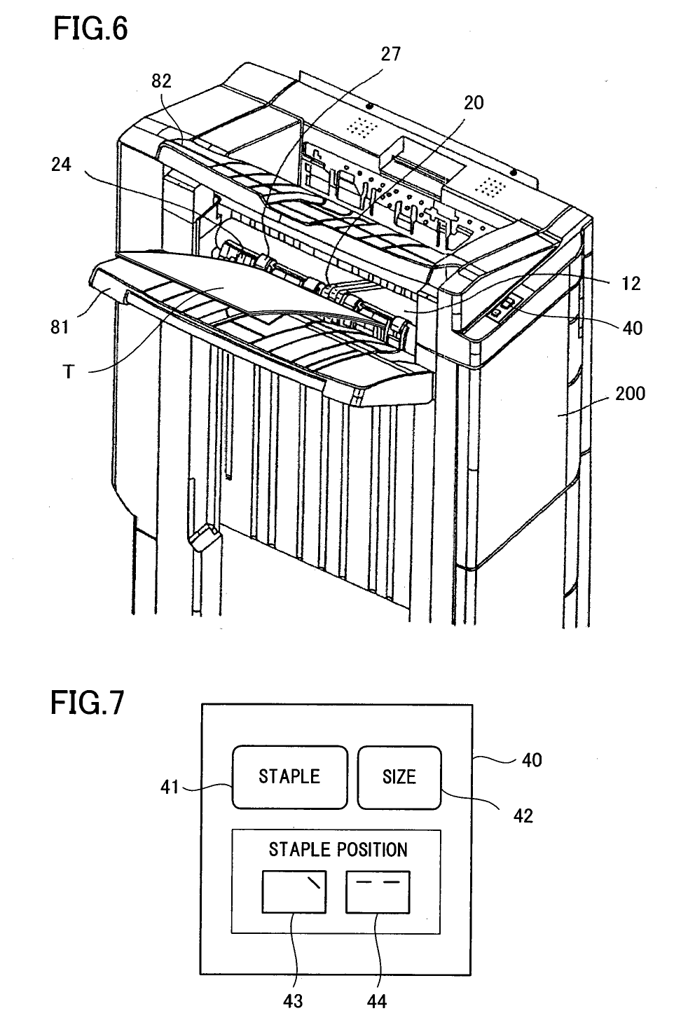

That is, in the manual mode, as shown in FIG. 6, the user inserts a sheet bundle T from the discharge port 24 into the processing tray 12. An operation panel 40 for manual stapling is provided at the upper part of the finisher 200.

FIG. 7 is a plan view showing an example of the operation panel 40. The operation panel 40 includes a staple button 41, a size selection button 42, and selection buttons 43 and 44 to specify a staple position. Each of the buttons 41 to 44 is a button of a type in which an LED is lighted. For example, when the staple button 41 is pressed, the staple button 41 and the size button 42 are lighted. When the size of the sheet is selected by the size button 42, the selection buttons 43 and 44 of the staple position are lighted. When one of the buttons 43 and 44 is selected, the staple button 41 blinks. When the staple button 41 is pressed, the stapler 13 performs stapling.

Incidentally, when the staple button 41 of the operation panel 40 is pressed, the storage tray 81 moves up or down so that the upper surface of the storage tray 81 becomes almost equal to the surface of the processing tray 12. As shown in FIG. 6, when the sheet bundle T is inserted from the discharge port 24, the inserted sheets are dropped from the processing tray 12 to the stapler 13. In response to the operation of the operation panel 40, the stapler 13 staples the dropped sheets.

In the manual stapling, the sheet bundle T is inserted into the stapler 13 from the discharge port 24 of the finisher. However, in the manual stapling, there is a case where the sheet bundle is not aligned, or the stapled position is shifted, and stapling can not be correctly performed.

In the embodiment, a guide material for positioning is provided on the storage tray 81, and the insertion position of the sheet bundle can be aligned using the guide material, or the positioning and alignment can be performed.

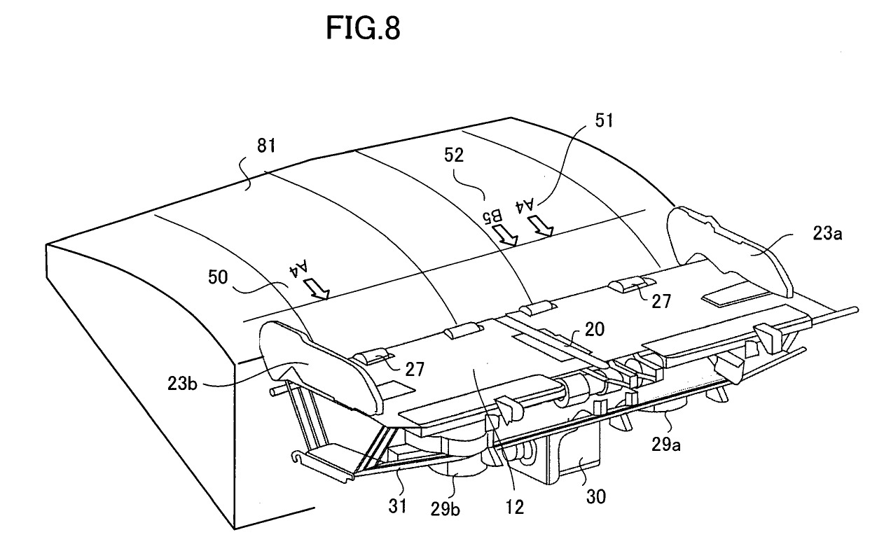

FIG. 8 is a perspective view showing a structure of a main part of the embodiment, and is a view of the storage tray 81 seen from the processing tray 12 side.

In FIG. 8, guide materials 50, 51 and 52 are marked on the upper surface of the storage tray 81. Each of the guide materials 50, 51 and 52 includes a sheet size (for example, A4, A5, etc.) and an arrow indicating a sheet insertion direction, and the marking positions of the guide materials 50, 51 and 52 are changed according to the sheet size. For example, when an A4 size sheet bundle T is inserted, the sheet bundle T is aligned between the guide materials 50 and 51 marked “A4” and is inserted. Besides, when a B5 size sheet bundle T is inserted, the sheet bundle T is aligned between the guide material 52 marked “B5” and the guide material 50, and is inserted. The guide material 50 is the reference guide material when an A4 size and a B5 size sheets are inserted.

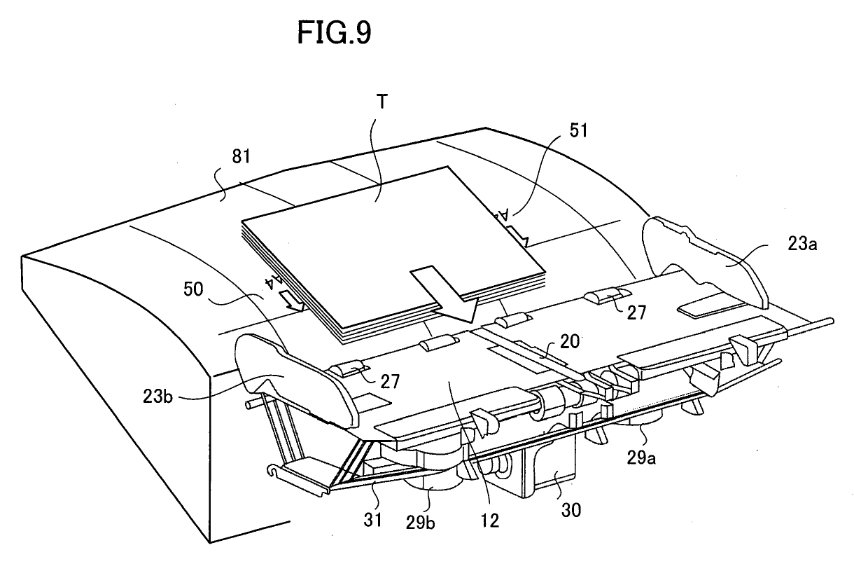

FIG. 9 shows a state where an A4-size sheet bundle T is inserted into the processing tray 12. The sheet bundle T is inserted so as to be positioned between the guide materials 50 and 51.

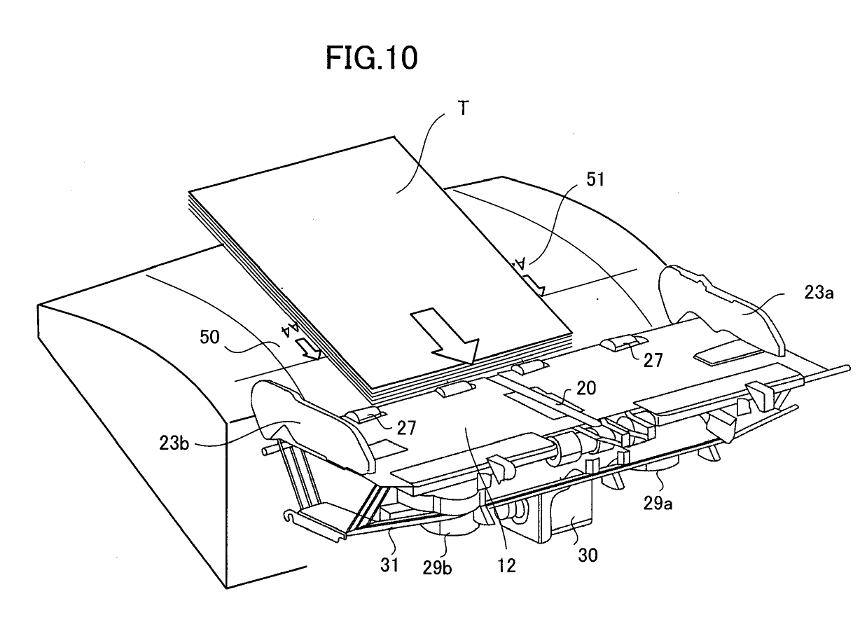

FIG. 10 shows a state where an A3 size sheet bundle T is inserted. The A3 size sheet bundle T is inserted using the same guide materials 50 and 51 as those used for A4.

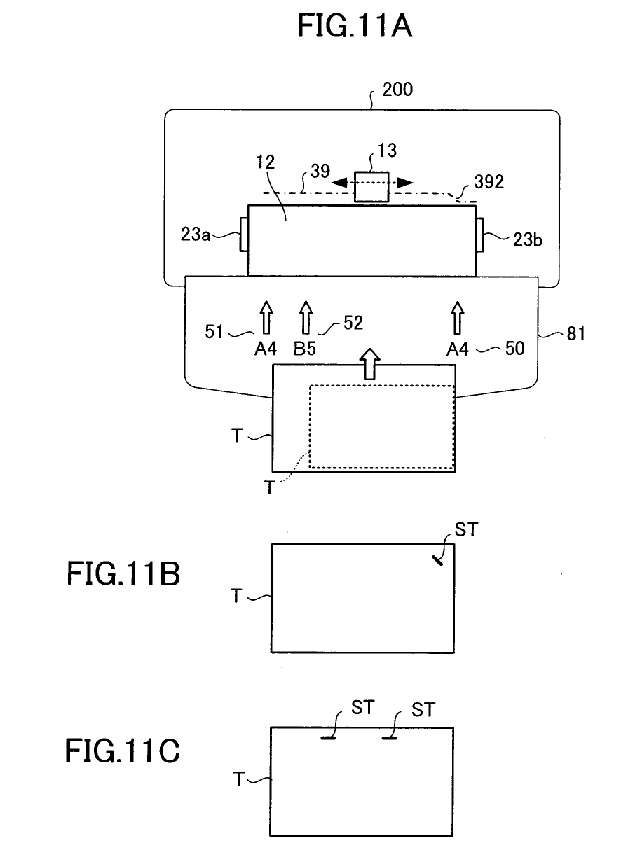

FIG. 11A is a plan view showing an insertion example of the sheet bundle T in the manual mode. The storage tray 81 is marked with the guide materials 50, 51 and 52 for respective sizes. Thus, for example, when the A4 size sheet bundle T is inserted, the sheet bundle T is placed between the guide materials 50 and 51 and is inserted.

FIG. 11B shows an example in which a corner part of the sheet bundle T is stapled. The stapling of the corner part is performed by pressing the selection button 43 of FIG. 7. The stapler 13 moves to the position of the inclined part 392 of the slit 39 (FIG. 5), and staples the corner part of the sheet bundle T.

FIG. 11C shows an example in which stapling is performed at two positions of an edge of the sheet bundle T. Reference sign ST denotes a staple position. The two-position stapling is performed by pressing the selection button 44 of FIG. 7. The stapler 13 moves along the straight portion 391 of the slit 39 (FIG. 5), and staples the edge of the sheet bundle T at two positions.

When an A5 size sheet bundle T (indicated by a dotted line) is stapled, the sheet bundle T is placed between the guide materials 50 and 52 and is inserted. When stapling is performed at a corner part of a B5 size sheet bundle, the selection button 43 of FIG. 7 is pressed. Then, the stapler 13 moves to the position of the inclined portion 392 of the slit 39 (FIG. 5), and stapling is performed at the corner part of the sheet bundle T. Similarly, when stapling is performed at two positions of the edge of the sheet bundle T, the selection button 44 of FIG. 7 is pressed. The stapler 13 moves along the straight portion 391 of the slit 39 (FIG. 5), and staples the edge of the sheet bundle T at two positions. However, the stapling interval and position are changed according to the sheet size.

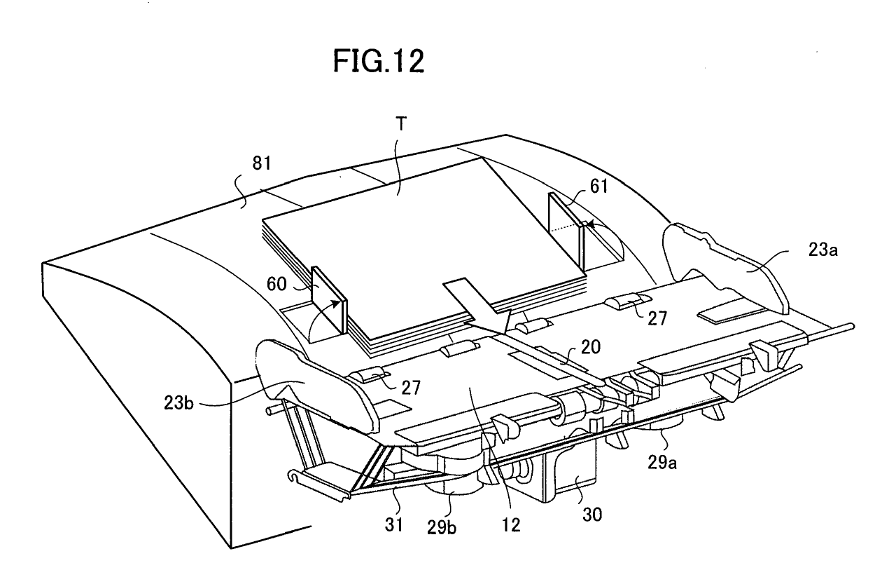

FIG. 12 is a perspective view showing a structure of a main part of another embodiment. In FIG. 12, openable and closable guide materials 60, 61 and 62 (guide material 62 is not seen in FIG. 12) are provided on a storage tray 81. The guide materials 60 and 61 normally fall and are flush with the upper surface of the storage tray 81, and can be extracted by the user into a raised state. FIG. 12 shows the state where the guide materials 60 and 61 are raised.

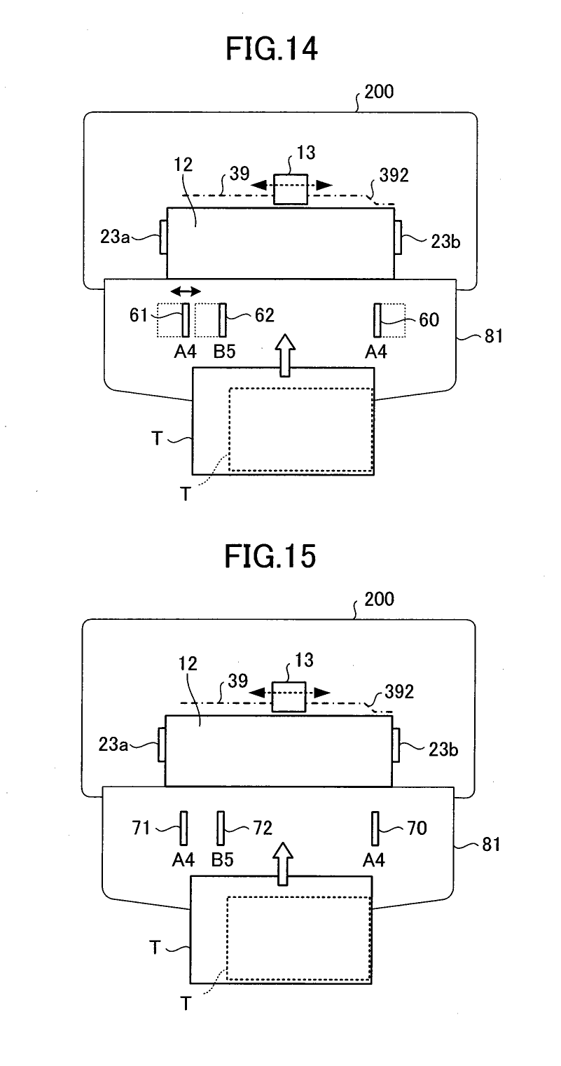

For example, when an A4 size sheet bundle T is inserted, the sheet bundle. T is inserted so as to be put between the guide materials 60 and 61. The sheet bundle T is aligned by the guide materials 60 and 61 and is inserted. Besides, when a B5 size sheet bundle T is inserted, the guide material 62 is raised (FIG. 14), and the sheet bundle T is put between guide material 60 and the guide material 62 and is inserted. Accordingly, the guide materials 60, 61 and 62 function as alignment plates. The guide material 60 is the reference guide material when the A4 size and the B5 size sheets are inserted.

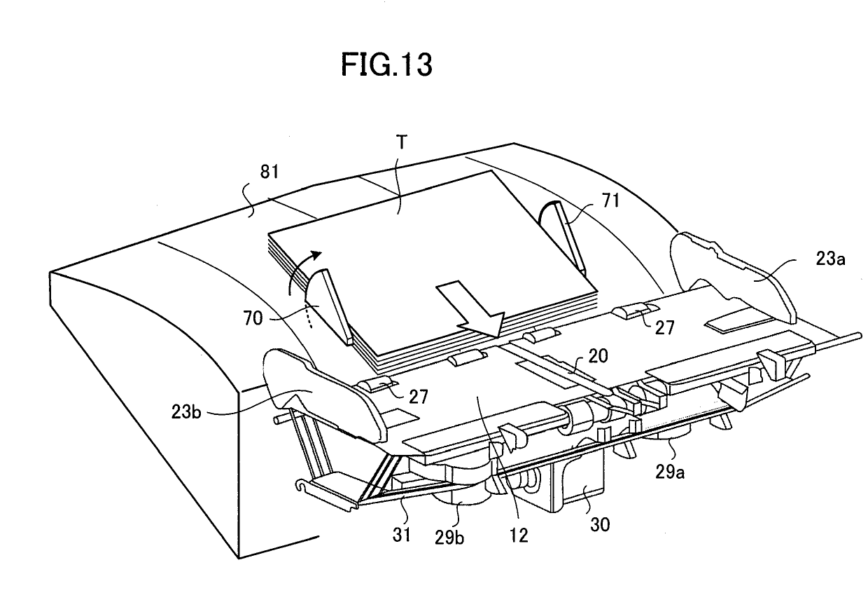

FIG. 13 is a perspective view showing a structure of a main part of a still another embodiment. In FIG. 13, guide materials 70, 71 and 72 (guide material 72 is not seen in FIG. 12) retractable in a storage tray 81 are provided. The guide materials 70 and 71 are normally received in the storage tray 81 and are flush with the upper surface of the storage tray 81, and can be rotated into a raised state by the user. FIG. 13 shows the state where the guide materials 70 and 71 are raised.

For example, when an A4 size sheet bundle T is inserted, the guide materials 70 and 71 are raised, and the sheet bundle T is put between the raised guide materials 70 and 71 and are inserted. The sheet bundle T is aligned by the guide materials 70 and 71 and are inserted. Besides, when a B5 size sheet bundle T is inserted, the guide material 72 (FIG. 15) provided to be closer to the guide material 70 than the guide material 71 is raised, and the sheet bundle T is put between the guide material 70 and the guide material 72 and is inserted. Accordingly, the guide materials 70, 71 and 72 function as alignment plates. The guide material 70 is the reference guide material when the A4 size and the B5 size sheets are inserted.

FIG. 14 is a plan view showing an insertion example of a sheet bundle T in a manual mode using the guide materials 60, 61 and 62 of FIG. 12. The storage tray 81 is provided with the guide materials 60, 61 and 62. Although the guide materials 60, 61 and 62 normally fall and are flush with the upper surface of the storage tray 81, in the manual mode, they can be rotated into the raised state by the user. When an A4 size sheet bundle T is inserted, the guide materials 60 and 61 are raised, and the sheet bundle T is put between the guide materials 60 and 61 and can be inserted. When a B5 size sheet bundle T (dotted line) is inserted, the guide materials 60 and 62 are raised, and the sheet bundle T is put between the guide materials 60 and 62 and can be inserted.

Besides, the guide material 62 is omitted, and the guide material 61 may be made movable to the guide material 60 side. When the guide material 61 is moved in a direction of moving away from the guide material 60, the A4 size sheet bundle T is put between the guide materials 60 and 61 and can be inserted. Besides, when a B5 size sheet bundle T (dotted line) is inserted, the guide material 61 is moved to the guide material 60 side, and the B5 size sheet bundle T is put between the guide material 60 and the moved guide material 61 and can be inserted. Incidentally, in the structure in which the guide material 61 is moved, the movement distance is the distance previously set according to the sheet size.

FIG. 15 is a plan view showing an insertion example of a sheet bundle T in the manual mode where the guide materials 70, 71 and 72 of FIG. 13 are used. The storage tray 81 is provided with the guide materials 70, 71 and 72. The guide materials 70, 71 and 72 are normally received in the storage tray 81; and are rotated in the raised state at the time of the manual mode. When an A4 size sheet bundle T is inserted, the guide materials 70 and 71 are raised, and the sheet bundle T is put between the guide materials 70 and 71 and can be inserted. Besides, when a B5 size sheet bundle T (dotting line) is inserted, the guide materials 70 and 72 are raised, and the sheet bundle T is put between the guide materials 70 and 72 and can be inserted.

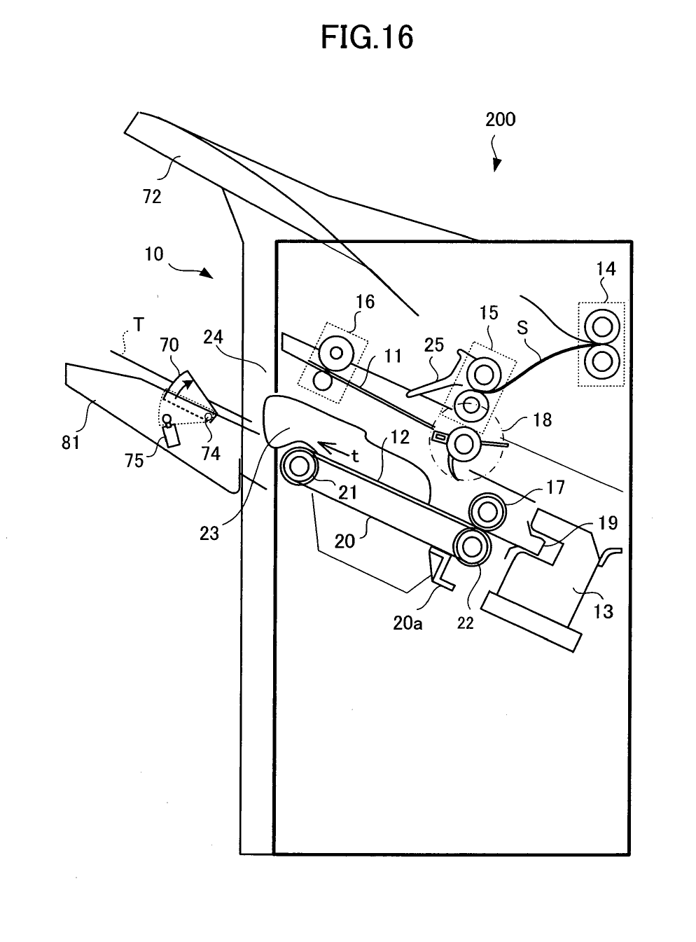

Incidentally, although the guide materials 70, 71 and 72 are raised by being pulled by the finger of the user, a push-push type opening and closing mechanism 75 may be used. That is, as shown in FIG. 16, the guide material 70 (71, 72) can rotate around a fulcrum 74, and is normally received in the storage tray 81. The push-push type opening and closing mechanism 75 is attached to the opposite side to the fulcrum 74 of the guide material 70 (71, 72).

The guide material 70 (71, 72) is locked at a position where it is received in the storage tray 81. When the user presses the guide material 70 (71, 72) from above, the lock is released, and the guide material 70 (71, 72) is rotated and raised by a spring force. Besides, when the raised guide material 70 (71, 72) is again pressed, received in the storage tray 81 and is locked at the received position.

Besides, the push-push type opening mechanism 75 can be used also for the opening and closing of the guide materials 60 and 61.

Incidentally, in the foregoing embodiments, although stapling on the A4 size and the B5 size sheets is described, when stapling is performed on another size of sheet, the stapling can be performed by increasing the number of guide materials. Besides, the marking design of the guide materials 50, 51 and 52, and the shape and size of the guide materials 60, 61 and 62 and the guide materials 70, 71 and 72 are not limited to the illustrated example, and can be modified according to actual conditions.

Besides, when, the size button 42 of the operation panel 40 is pressed, the push-push type opening and closing mechanism 75 is controlled, and one of the corresponding guide materials 70, 71 and 72 may be automatically raised. That is, a release member to release the lock of the push-push type opening and closing mechanism 75 is provided, and control is made such that when the size button 42 is pressed, the lock of the corresponding guide material 70, 71 or 72 is released and it is raised.

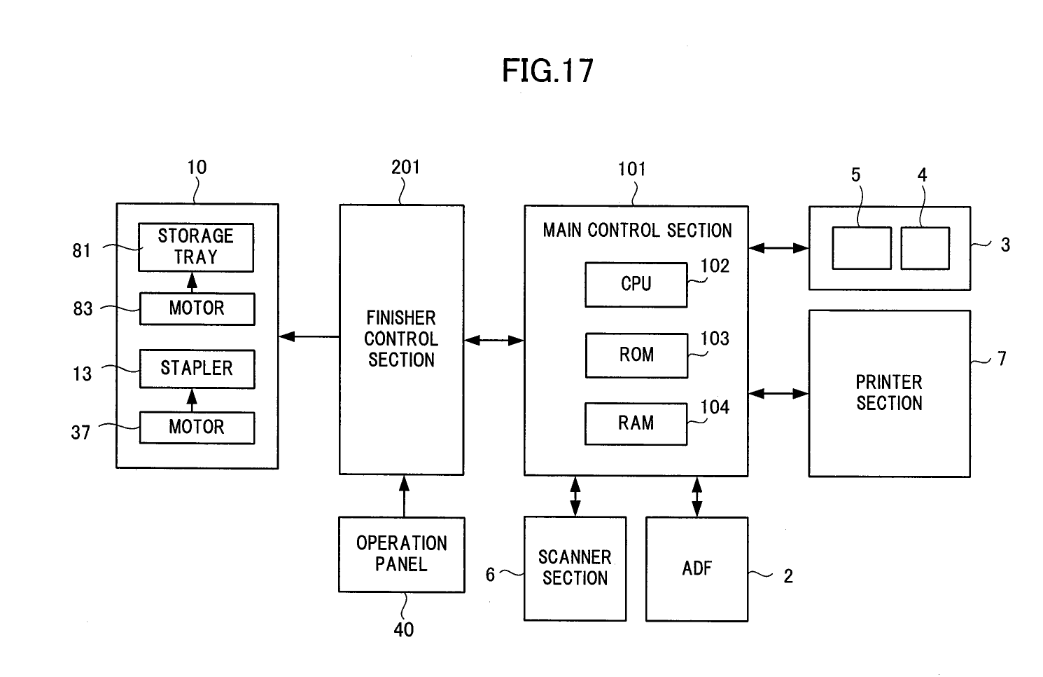

FIG. 17 is a block diagram showing a control system of the image forming apparatus 100 and the finisher 200. In FIG. 17, a main control section 101 includes a CPU 102, a ROM 103, and a RAM 104, and the CPU 102 controls the image forming apparatus 100 in accordance with a control program stored in the ROM 103. Besides, the main control section 101 responds to the operation of the operation panel 3, and controls the operation of the ADF 2, the scanner section 6 and the printer section 7. The RAM 104 temporarily stores control data and is used for arithmetic operation at the time of control.

The operation panel 3 includes the plural keys 4 and the display section 5 used also as a touch panel, and can give various instructions for image formation. For example, the instruction of the number of copies is performed using the key 4, and the instructions of the sheet size, sheet type, punching, and stapling are performed b operating the touch panel of the display section 5.

A finisher control section 201 controls the operation of the finisher 200 (staple unit 10) and the operation of sheet discharge. The finisher control section 201 is connected to the main control section 101, transmits and receives information to and from the main control section 101, and the image forming apparatus 100 and the finisher 200 operate in cooperation with each other.

When the staple button 41 of the operation panel 40 is pressed in the manual mode, the finisher control section 201 drives the motor 83 to move the storage tray 81 up and down, and controls so that the height of the storage tray 81 is equal to the height of the processing tray 12. When the instructions of the sheet size and staple position are given from the operation panel 40, the position of the stapler 13 is controlled and stapling is performed.

In the embodiments as described above, when stapling is performed in the manual mode, the sheet bundle can be inserted at the correct position toward the stapler, and a variation in the staple position can be prevented. Besides, the sheet bundle can be aligned by the guide materials and can be inserted.

While certain embodiments have been described, these embodiments have been presented by way of example only, and are not intended to limit the scope of the invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A sheet processing apparatus comprising:
a processing tray on which a sheet conveyed from an image forming apparatus is placed;
a stapler to staple the sheet placed on the processing tray;
a sheet discharge section to discharge the stapled sheet from the processing tray to a discharge port;
a liftable storage tray on which the sheet discharged from the discharge port is stacked; and
a guide material which is provided on the storage tray and guides insertion of a sheet when the sheet is inserted from the discharge port into the stapler and manual stapling is performed.

2. The apparatus of claim 1, wherein the storage tray is provided with a first guide material with reference to a position of the stapler when a corner part of the sheet is stapled, and is provided with another guide material at a position opposite to the first guide material according to a sheet size.

3. The apparatus of claim 1, wherein the guide material is a marking to guide an insertion position of the sheet for each size.

4. The apparatus of claim 1, wherein the guide material includes a plurality of alignment plates to guide an insertion position of the sheet for each size, and each of the plurality of alignment plates can be opened and closed between a first state where the alignment plate is flush with an upper surface of the storage tray and a second state where the alignment plate is raised from the upper surface of the storage tray.

5. The apparatus of claim 4, wherein the guide material includes a pair of openable and closable alignment plates, and with respect to one of the alignment plates as a reference, the other of the alignment plates can be moved according to a sheet size.

6. The apparatus of claim 1, wherein the guide material includes a plurality of alignment plates to guide an insertion position of the sheet for each size, and each of the plurality of alignment plates can be extracted between a state where the alignment plate is received in the storage tray and a state where the alignment plate is raised from an upper surface of the storage tray.

7. The apparatus of claim 6, wherein each of the plurality of alignment plates is supported in the storage tray by a push-push type opening and closing mechanism.

8. The apparatus of claim 1, further comprising an operation panel to specify a sheet size and to select a staple position when the manual stapling is performed.

9. The apparatus of claim 8, wherein the operation panel selects whether stapling is performed on a corner part of the sheet or stapling is performed at a plurality of positions of an edge of the sheet.

10. The apparatus of claim 8, wherein when the manual stapling is instructed by the operation panel, the storage tray moves up or down to a height position of the discharge port.

11. A sheet processing method comprising:
placing a sheet conveyed from an image forming apparatus on a processing tray;
stapling the sheet placed on the processing tray by a stapler;
discharging the stapled sheet from the processing tray to a discharge port;
stacking the sheet discharged from the discharge port on a liftable storage tray; and
guiding insertion of a sheet by a guide material provided on the storage tray when the sheet is inserted from the discharge port into the stapler and manual stapling is performed.

12. The method of claim 11, wherein a first guide material is provided with reference to a position of the stapler when a corner part of the sheet is stapled, and
another guide material is provided at a position opposite to the first guide material according to a sheet size.

13. The method of claim 11, wherein a marking to guide an insertion position of the sheet for each size is provided as the guide material.

14. The method of claim 11, wherein a plurality of alignment plates to guide an insertion position of the sheet for each size are provided as the guide material, and each of the plurality of alignment plates can be opened and closed between a first state where the alignment plate is flush with an upper surface of the storage tray and a second state where the alignment plate is raised from the upper surface of the storage tray.

15. The method of claim 14, wherein a pair of openable and closable alignment plates are provided on the storage tray, and with respect to one of the alignment plates as a reference, the other of the alignment plates can be moved according to a sheet size.

16. The method of claim 11, wherein a plurality of alignment plates to guide an insertion position of the sheet for each size is provided as the guide material, and each of the plurality of alignment plates can be extracted between a state where the alignment plate is received in the storage tray and a state where the alignment plate is raised from an upper surface of the storage tray.

17. The method of claim 16, wherein each of the plurality of alignment plates is supported in the storage tray by a push-push type opening and closing mechanism.

18. The method of claim 11, wherein when the manual stapling is performed, a sheet size is specified and a staple position is selected by an operation panel.

19. The method of claim 18, wherein the operation panel is used to select whether stapling is performed on a corner part of the sheet or stapling is performed at a plurality of positions of an edge of the sheet.

20. The method of claim 19, wherein when the manual stapling is instructed by the operation panel, the storage tray moves up or down to a height position of the discharge port.
